(19) United States
(12) Patent Application Publication
(10) Pub. No.: US 2023/0368124 A1
(43) Pub. Date: Nov. 16, 2023

(54) DELIVERY MANAGEMENT DEVICE, DELIVERY SYSTEM, DELIVERY MANAGEMENT METHOD, AND STORAGE MEDIUM STORING DELIVERY MANAGEMENT PROGRAM

(71) Applicant: Mitsubishi Electric Corporation, Tokyo (JP)

(72) Inventors: Kentaro ISHIKAWA, Tokyo (JP); Yoshie IMAI, Tokyo (JP); Masato TSUCHIYA, Tokyo (JP); Nobuaki MOTOYAMA, Tokyo (JP); Masahiro ABUKAWA, Tokyo (JP); Satoru FURUTA, Tokyo (JP)

(73) Assignee: Mitsubishi Electric Corporation, Tokyo (JP)

(21) Appl. No.: 18/226,630

(22) Filed: Jul. 26, 2023

Related U.S. Application Data
(63) Continuation of application No. PCT/JP2021/010008, filed on Mar. 12, 2021.

(51) Int. Cl. G06Q 10/0835; G06Q 10/0833; G06Q 10/0832

(52) U.S. Cl. CPC G06Q 10/08355; G06Q 10/0833; G06Q 10/0832

(57) ABSTRACT

A delivery management device includes a communication unit and a control unit. The control unit acquires vehicle position information and user position information when a request for delivery of a parcel is received, selects one vehicle among a plurality of vehicles based on contents of the request, information acquired from a storage device, the vehicle position information and the user position information, makes the selected vehicle as a responsible vehicle move to the user present position, and receives a pickup completion notification indicating that the responsible vehicle moved to the user present position and a shipment parcel has been loaded onto the responsible vehicle or a completion notification indicating that the responsible vehicle arrived at the user present position and a reception parcel has been taken out of the responsible vehicle.

### CROSS-REFERENCE TO RELATED APPLICATION

This application is a continuation application of International Application No. PCT/JP2021/010008 having an international filing date of Mar. 12, 2021.

### BACKGROUND OF THE INVENTION

### 1. Field of the Invention

The present disclosure relates to a delivery management device, a delivery system, a delivery management method and a delivery management program.

### 2. Description of the Related Art

There has been proposed a delivery system including vehicles that carry parcels and a management server that communicates with the vehicles (see Patent Reference 1, for example). The management server transmits a command to a vehicle so that the vehicle arrives at a designated delivery destination at a set time. A user receives the parcel from the vehicle at the designated delivery destination at the set time.

Patent Reference 1: Japanese Patent Application Publication No. 2019-101463 (see paragraphs 0030 and 0031, FIG. 1 and FIG. 2, for example).

However, in the delivery system described above, the user needs to be at the designated place at the set time, and thus there is a problem in that the user's activity is restricted.

### SUMMARY OF THE INVENTION

An object of the present disclosure is to provide a delivery management device, a delivery system, a delivery management method and a delivery management program that make it possible to load a parcel onto a vehicle or take out a parcel from a vehicle without restricting the user's activity.

A delivery management device according to the present disclosure includes a communication unit to execute communication with a plurality of vehicles each of which autonomously travels in a predetermined area and to output vehicle position information indicating a vehicle present position; and a control unit to acquire information from a storage device storing map information indicating a map of the predetermined area, vehicle information indicating types of the plurality of vehicles, and user information including information regarding a user terminal outputting user position information indicating a user present position and information regarding a user, and to issue commands regarding the traveling of the plurality of vehicles based on the information. The control unit acquires the vehicle position information and the user position information when a request for delivery of a parcel is received, the request including no designated pickup position of a shipment parcel in the predetermined area or no designated reception position of a reception parcel in the predetermined area, selects one vehicle among the plurality of vehicles based on contents of the request, the information acquired from the storage device, the vehicle position information and the user position information and makes the selected vehicle as a responsible vehicle move to the user present position, and receives a pickup completion notification indicating that the responsible vehicle moved to the user present position and the shipment parcel has been loaded onto the responsible vehicle or a delivery completion notification indicating that the responsible vehicle arrived at the user present position and the reception parcel has been taken out of the responsible vehicle.

A delivery management method according to the present disclosure is a method executed by a delivery management device that executes communication with a plurality of vehicles each of which autonomously travels in a predetermined area and outputs vehicle position information indicating a vehicle present position, acquires information from a storage device storing map information indicating a map of the predetermined area, vehicle information indicating types of the plurality of vehicles, and user information including information regarding a user terminal outputting user position information indicating a user present position and information regarding a user, and issues commands regarding the traveling of the plurality of vehicles based on the information. The method includes: acquiring the vehicle position information and the user position information when a request for delivery of a parcel is received, the request including no designated pickup position of a shipment parcel in the predetermined area or no designated reception position of a reception parcel in the predetermined area; selecting one vehicle among the plurality of vehicles based on contents of the request, the information acquired from the storage device, the vehicle position information and the user position information and making the selected vehicle as a responsible vehicle move to the user present position; and receiving a pickup completion notification indicating that the responsible vehicle moved to the user present position and the shipment parcel has been loaded onto the responsible vehicle or a delivery completion notification indicating that the responsible vehicle arrived at the user present position and the reception parcel has been taken out of the responsible vehicle.

According to the present disclosure, it is possible to load a parcel onto a vehicle or take out a parcel from a vehicle without restricting the user's activity.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram schematically showing a configuration of a delivery system according to an embodiment;

FIG. 2 is a diagram schematically showing a commercial facility in an area shown in FIG. 1;

FIG. 3 is a functional block diagram schematically showing a configuration of a management server in FIG. 1;

FIG. 4 is a diagram showing a hardware configuration of the management server in FIG. 3;

FIG. 5 is a functional block diagram schematically showing a configuration of a vehicle in FIG. 1;

FIG. 6 is a diagram showing a hardware configuration of the vehicle in FIG. 5;

FIG. 7 is a functional block diagram schematically showing a configuration of a user terminal in FIG. 1;

FIG. 8 is a diagram showing a hardware configuration of the user terminal in FIG. 7;

FIG. 9 is a functional block diagram schematically showing a configuration of a shop terminal in FIG. 1;

FIG. 10 is a diagram showing a hardware configuration of the shop terminal in FIG. 9;

FIG. 11 is a functional block diagram schematically showing a configuration of a hotel terminal in FIG. 1;

FIG. 12 is a diagram showing a hardware configuration of the hotel terminal in FIG. 11;

FIGS. 13A to 13F are schematic diagrams for explaining a first operation example of the delivery system according to the embodiment;

FIG. 14 is a sequence diagram showing an operation of the user terminal, the vehicles and the management server in the first operation example;

FIG. 15 is a flowchart showing an operation of the management server in the first operation example;

FIGS. 16A to 16E are schematic diagrams for explaining a second operation example of the delivery system according to the embodiment;

FIG. 17 is a sequence diagram showing an operation of the user terminal, the vehicles and the management server in the second operation example;

FIG. 18 is a flowchart showing an operation of the management server in the second operation example;

FIGS. 19A to 19E are schematic diagrams for explaining a third operation example of the delivery system according to the embodiment;

FIG. 20 is a sequence diagram showing an operation of the user terminal, the vehicles and the management server in the third operation example;

FIG. 21 is a flowchart showing an operation of the management server in the third operation example;

FIGS. 22A to 22F are schematic diagrams for explaining a fourth operation example of the delivery system according to the embodiment;

FIG. 23 is a sequence diagram showing an operation of the user terminal, the vehicles and the management server in the fourth operation example;

FIG. 24 is a flowchart showing an operation of the management server in the fourth operation example;

FIGS. 25A to 25E are schematic diagrams for explaining a fifth operation example of the delivery system according to the embodiment;

FIG. 26 is a sequence diagram showing an operation of the user terminal, the vehicles and the management server in the fifth operation example;

FIG. 27 is a flowchart showing an operation of the management server in the fifth operation example;

FIGS. 28A to 28F are schematic diagrams for explaining a sixth operation example of the delivery system according to the embodiment;

FIG. 29 is a sequence diagram showing an operation of the user terminal, the vehicles and the management server in the sixth operation example; and

FIG. 30 is a flowchart showing an operation of the management server in the sixth operation example.

### DETAILED DESCRIPTION OF THE INVENTION

A delivery management device, a delivery system, a delivery management method and a delivery management program according to an embodiment will be described below with reference to the drawings. The following embodiments are just examples and it is possible to appropriately combine embodiments and appropriately modify each embodiment.

### (Delivery System)

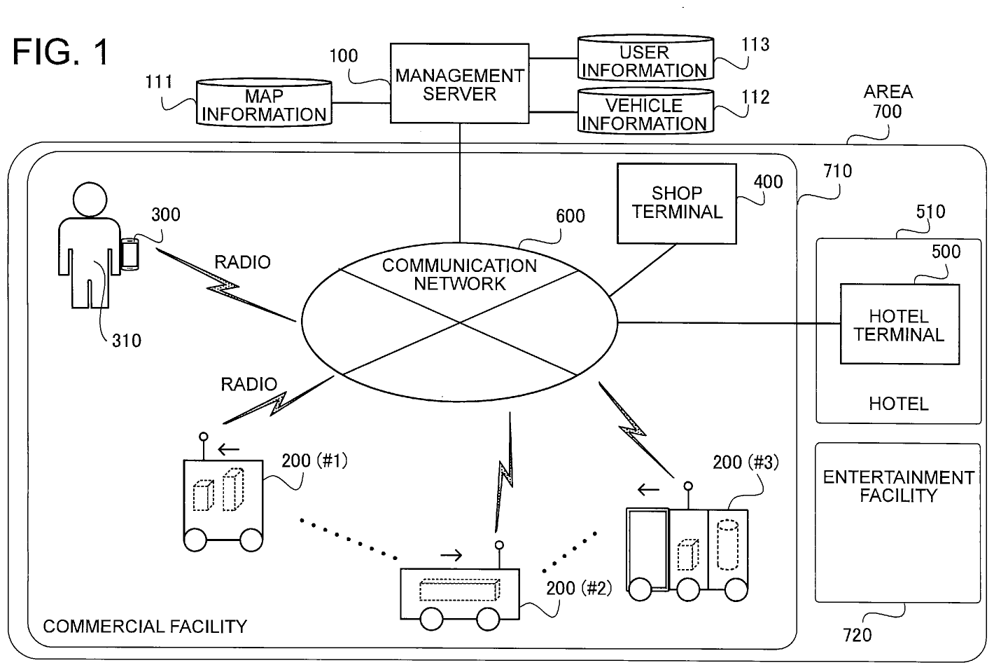

FIG. 1 is a diagram schematically showing the configuration of a delivery system according to the embodiment. As shown in FIG. 1, the delivery system according to the embodiment includes a management server 100 as a delivery management device and a plurality of vehicles 200 as a plurality of autonomous traveling vehicles that autonomously travel in a previously predetermined area 700. The management server 100 is a device capable of executing a delivery management method according to the embodiment. The management server 100 is a computer, for example. The management server 100 is capable of executing a delivery management program according to the embodiment.

In the example of FIG. 1, facilities are provided in the area 700. In the example of FIG. 1, a commercial facility 710, an entertainment facility 720 and a hotel 510 as an accommodation facility are provided in the area 700. However, facilities in the area 700 are not limited to the illustrated facilities.

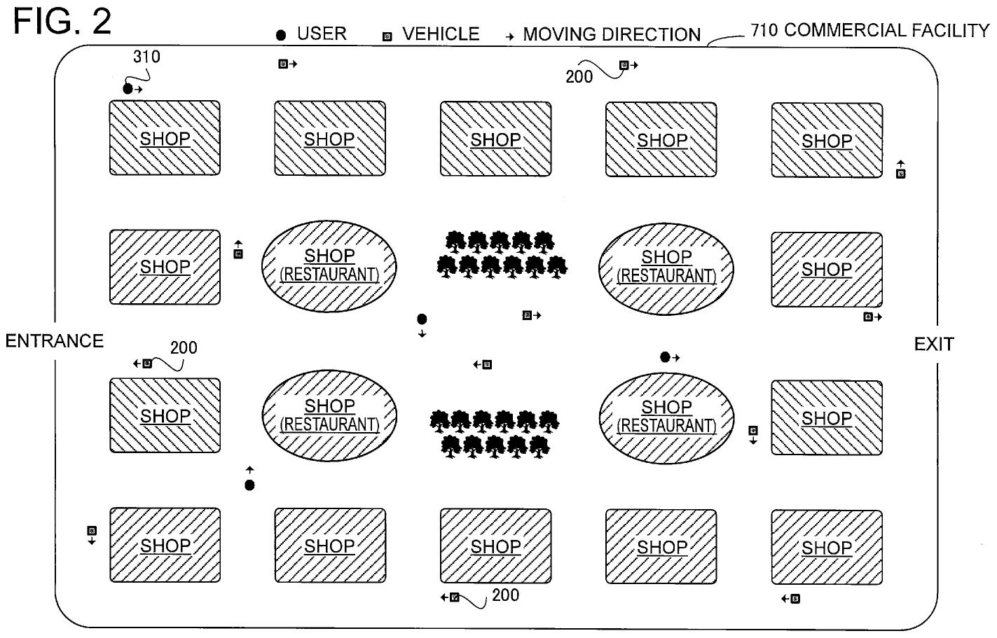

FIG. 2 is a diagram schematically showing the commercial facility 710 in the area 700 shown in FIG. 1. FIG. 1 and FIG. 2 illustrate a user 310 using the commercial facility 710, a user terminal 300 carried by the user 310 such as a smartphone, a shop terminal 400 provided in a shop (e.g., register), and a plurality of vehicles 200 (#1, #2 , #3). The plurality of vehicles 200 are desired to include a plurality of types of vehicles differing in the type (e.g., capacity of a storage compartment, presence/absence of the refrigeration function, capacity of a rechargeable battery supplying electric power for the traveling, or the like). However, the number of users 310, the number of user terminals 300, the number of shop terminals 400, and the number and types of vehicles 200 are not limited to those shown in FIG. 1 and FIG. 2.

The management server 100 is capable of accessing map information 111 indicating a map of the area 700, vehicle information 112 indicating the types of the plurality of vehicles 200, and user information 113. The user information 113 includes information regarding the user terminal 300 outputting user position information U indicating a user present position (e.g., information identifying the user terminal 300) and information regarding the user 310 (e.g., information identifying the user). The information regarding the user 310 can include, for example, personal information on the user 310 (e.g., attribute information such as the full name, sex and age) and information regarding a family accompanying the user 310 (e.g., a group moving together with the user 310 such as the user 310's wife or child). Information regarding a person accompanying the user 310 (e.g., a group moving together with the user 310 such as a colleague or friend of the user 310) may be included in the information regarding the family. The user information 113 is, for example, information that has previously been registered for a trip using the hotel 510. The map information 111, the vehicle information 112 and the user information 113 are acquired from a storage device of the management server 100 or an external storage device. The external storage device can be a storage device of another server connected to a communication network 600. The communication network 600 is the Internet, for example.

The management server 100, the plurality of vehicles 200, one or more user terminals 300, one or more shop terminals 400, and terminals of other facilities (e.g., hotel terminal 500 provided in the hotel 510) are capable of communicating with each other via the communication network 600, for example. The management server 100 issues commands regarding the traveling of the plurality of vehicles 200 based on the map information 111, the vehicle information 112 and the user information 113 For example, as shown in FIG. 2, the plurality of vehicles 200 may move in the commercial facility 710 according to previously set schedules and previously set travel routes.

When a request for the delivery of a parcel is received, the management server 100 acquires vehicle position information V from the vehicles 200, acquires the user position information U from the user terminal 300. The request for the delivery of a parcel may includes no designated pickup position (i.e., no pickup position designated by the user, for example) of a shipment parcel in the predetermined area or no designated reception position (i.e., no reception position designated by the user, for example) of a reception parcel in the predetermined area. Then, the management server 100 selects (determines) one vehicle among the plurality of vehicles 200 based on the contents of the delivery request, the map information 111, the vehicle information 112, the user information 113, the vehicle position information and the user position information U, and makes the selected vehicle 200 as a responsible vehicle 210 move to the user present position. The determination of the responsible vehicle 210 may be made in consideration of the remaining battery charge of the rechargeable battery of each vehicle at the time of the determination and road conditions between each vehicle 200 and the user position (e.g., being under repair, being bumpy, etc.).

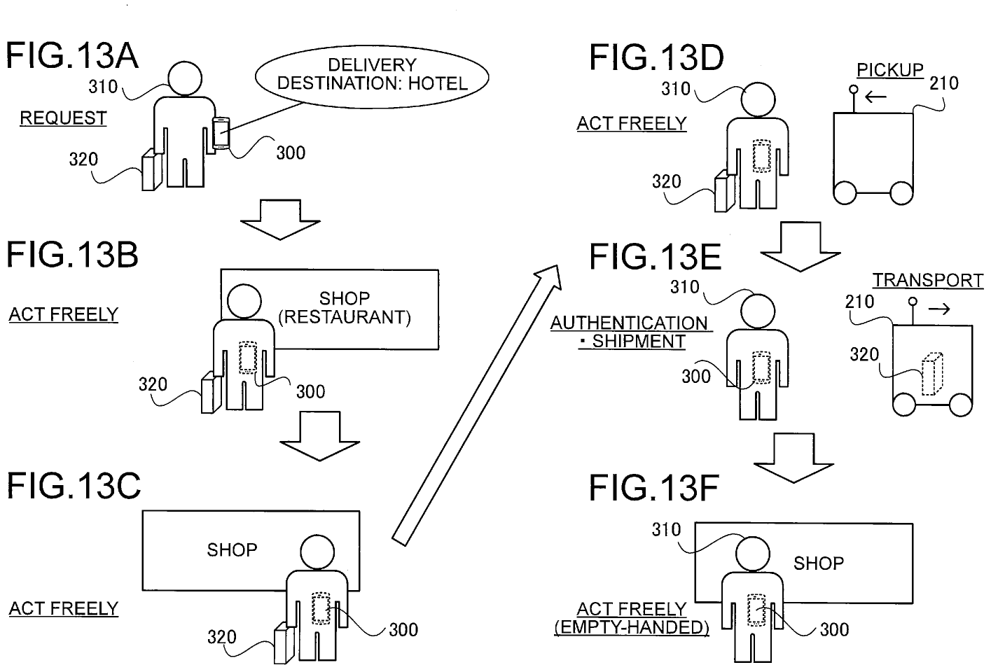

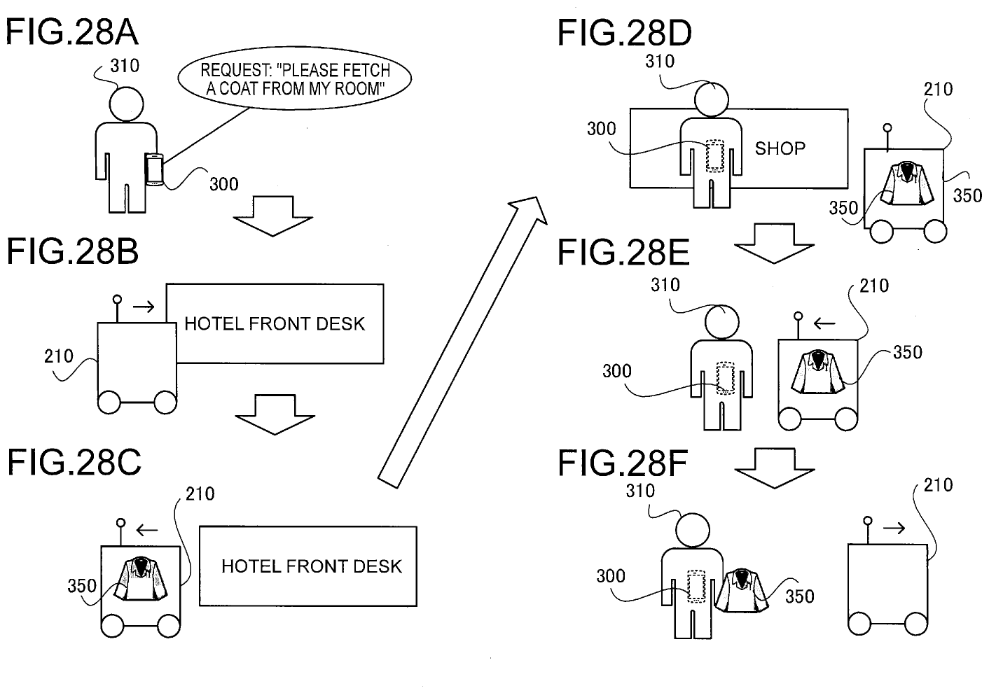

The management server 100 receives a pickup completion notification indicating that the responsible vehicle 210 arrived at the user present position and a shipment parcel (shown in FIGS. 13A-13F to FIG. 27 which will be explained later, for example) has been loaded onto the responsible vehicle 210 or a delivery completion notification indicating that the responsible vehicle 210 arrived at the user present position and a reception parcel (shown in FIG. 28 which will be explained later, for example) has been taken out of the responsible vehicle 210. The management server 100 receives the completion notification from the responsible vehicle 210, for example.

### (Management Server 100)

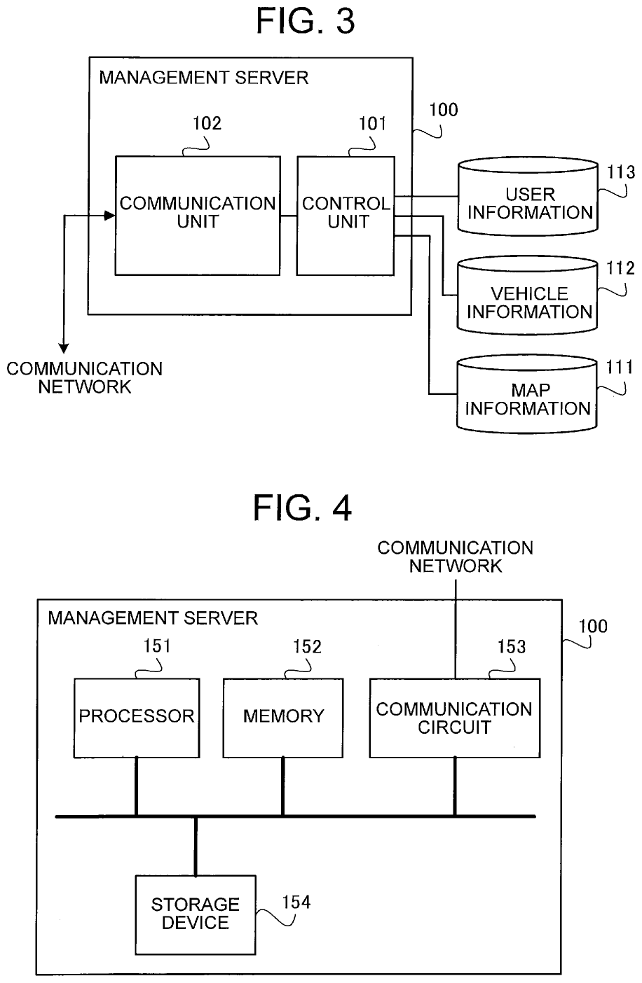

FIG. 3 is a functional block diagram schematically showing the configuration of the management server 100 in FIG. 1. As shown in FIG. 3, the management server 100 includes a communication unit 102 that executes communication with the plurality of vehicles 200 via the communication network 600 and a control unit 101 that acquires information from the storage device storing the map information 111, the vehicle information 112 and the user information 113 and issues commands regarding the traveling of the plurality of vehicles 200 based on the acquired information. When a request for the delivery of a parcel is received, the control unit 101 acquires the vehicle position information and the user position information U, selects one vehicle among the plurality of vehicles 200 based on the contents of the request, the information acquired from the storage device, the vehicle position information and the user position information U, and makes the selected vehicle 200 as the responsible vehicle 210 move to the user present position. The control unit 101 receives the pickup completion notification indicating that the responsible vehicle 210 arrived at the user present position and the shipment parcel has been loaded onto the responsible vehicle 210 or the delivery completion notification indicating that the responsible vehicle 210 arrived at the user present position and the reception parcel has been taken out of the responsible vehicle 210.

FIG. 4 is a diagram showing the hardware configuration of the management server 100 in FIG. 3. As shown in FIG. 4, the management server 100 includes a processor 151 such as a CPU (Central Processing Unit), a memory 152 as a volatile storage device, a communication circuit 153 that executes the communication, and a nonvolatile storage device 154 such as a hard disk drive (HDD) or a solid state drive (SSD). The memory 152 is a volatile semiconductor memory such as a RAM (Random Access Memory), for example.

Functions of the management server 100 are implemented by processing circuitry. The processing circuitry can be either dedicated hardware or the processor 151 executing a program stored in the memory 152. The processor 151 can be any one of a processing device, an arithmetic device, a microprocessor, a microcomputer and a DSP (Digital Signal Processor).

In the case where the processing circuitry is dedicated hardware, the processing circuitry is, for example, a single circuit, a combined circuit, a programmed processor, a parallelly programmed processor, an ASIC (Application Specific Integrated Circuit), an FPGA (Field-Programmable Gate Array) or a combination of some of these circuits.

In the case where the processing circuitry is the processor 151, the delivery management program is implemented by software, firmware, or a combination of software and firmware. The software and the firmware are described as programs and stored in the memory 152. The processor 151 implements the functions of the units shown in FIG. 3 by reading out and executing the delivery management program stored in the memory 152 as a storage device. The storage device may be a non-transitory computer-readable storage medium storing a program such as the delivery management program.

Incidentally, it is also possible to implement part of the management server 100 by dedicated hardware and part of the management server 100 by software or firmware. As above, the processing circuitry is capable of implementing the above-described functions by hardware, software, firmware or a combination of some of these means.

### (Vehicle 200)

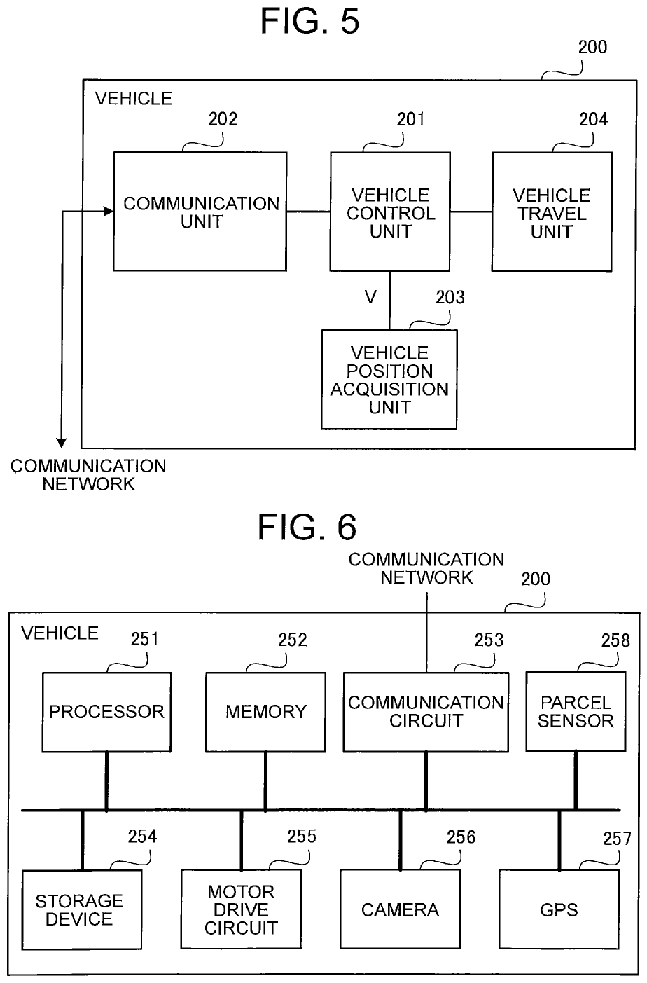

FIG. 5 is a functional block diagram schematically showing the configuration of the vehicle 200 in FIG. 1. As shown in FIG. 5, the vehicle 200 includes a communication unit 202 that executes communication with another device such as the management server 100 via the communication network 600, a vehicle control unit 201 that controls the traveling and the like of the vehicle 200, a vehicle position acquisition unit 203 such as a GPS (Global Positioning System) that acquires the vehicle position information as the position of the vehicle 200 (i.e., the position of the host vehicle 200), and a vehicle travel unit 204 that drives a motor and the like for making the vehicle 200 travel. The vehicle control unit 201 controls the operation of the vehicle travel unit 204 based on the vehicle position information V, the traveling command received from the management server 100, and the like. Further, when the host vehicle 200 is the responsible vehicle 210, the vehicle control unit 201 transmits the pickup completion notification indicating that the responsible vehicle 210 arrived at the user present position and the shipment parcel has been loaded onto the responsible vehicle 210 or the delivery completion notification indicating that the responsible vehicle 210 arrived at the user present position and the reception parcel has been taken out of the responsible vehicle 210. Furthermore, the vehicle control unit 201 may execute a process for authenticating the user storing the parcel or the user taking out the parcel from the storage compartment. The authentication can be carried out by means of near field communication with the user terminal 300, the inputting of a password, or the like, for example.

FIG. 6 is a diagram showing the hardware configuration of the vehicle 200 in FIG. 5. As shown in FIG. 6, the vehicle 200 includes a processor 251 such as a CPU, a memory 252 as a volatile storage device, a communication circuit 253 that executes the communication, a nonvolatile storage device 254, a motor drive circuit 255 that drives the motor for the traveling of the vehicle, a camera 256 that photographs the vicinity of the vehicle 200, and a GPS 257. The vehicle 200 is a device equipped with a computer, for example. The vehicle 200 may include a distance measurement sensor such as a LiDAR (Light Detection And Ranging) or a radar in addition to the camera 256 and use a captured image or information on a detected object for the control of the autonomous traveling of the vehicle 200. Further, the vehicle 200 may include a parcel sensor for detecting a state in which a parcel has been stored or no parcel has been stored and a function of notifying the management server 100 of the result of the detection by the parcel sensor.

Functions of the vehicle 200 are implemented by processing circuitry. The processing circuitry can be either dedicated hardware or the processor 251 executing a program stored in the memory 252 as a storage device. The storage device may be a non-transitory computer-readable storage medium storing the program. It is also possible to implement part of the configuration of a control system of the vehicle 200 by dedicated hardware and part of the configuration of the control system by software or firmware. As above, the processing circuitry is capable of implementing the above-described functions by hardware, software, firmware or a combination of some of these means.

### (User Terminal 300)

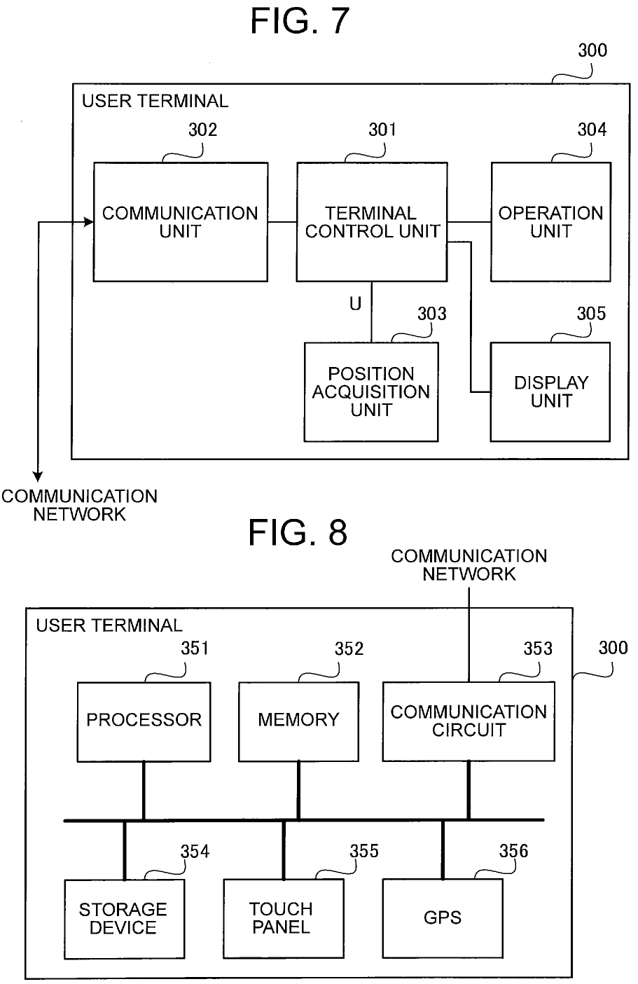

FIG. 7 is a functional block diagram schematically showing the configuration of the user terminal 300 in FIG. 1. As shown in FIG. 7, the user terminal 300 includes a communication unit 302 that executes communication with another device such as the management server 100 via the communication network 600, a terminal control unit 301, a position acquisition unit 303 such as a GPS that acquires the user position information U, an operation unit 304 on which user operations are performed, and a display unit 305 that displays information. The user terminal 300 is a smartphone (i.e., small-sized computer), for example. The terminal control unit 301 transmits a delivery request to the management server 100. Further, the terminal control unit 301 may be used for the authentication of the user when a parcel is stored in the vehicle 200 or when a parcel is taken out of the storage compartment. The authentication can be carried out by means of near field communication with the vehicle 200, for example.

FIG. 8 is a diagram showing the hardware configuration of the user terminal 300 in FIG. 7. As shown in FIG. 8, the user terminal 300 includes a processor 351 such as a CPU, a memory 352 as a volatile storage device, a communication circuit 353 that executes the communication, a nonvolatile storage device 354, a touch panel 355, and a GPS 356.

Functions of the user terminal 300 are implemented by processing circuitry. The processing circuitry can be either dedicated hardware or the processor 351 executing a program stored in the memory 352 as a storage device. The storage device may be a non-transitory computer-readable storage medium storing the program. It is also possible to implement part of the configuration of the user terminal 300 by dedicated hardware and part of the configuration of the user terminal 300 by software or firmware. As above, the processing circuitry is capable of implementing the above-described functions by hardware, software, firmware or a combination of some of these means.

### (Shop Terminal 400)

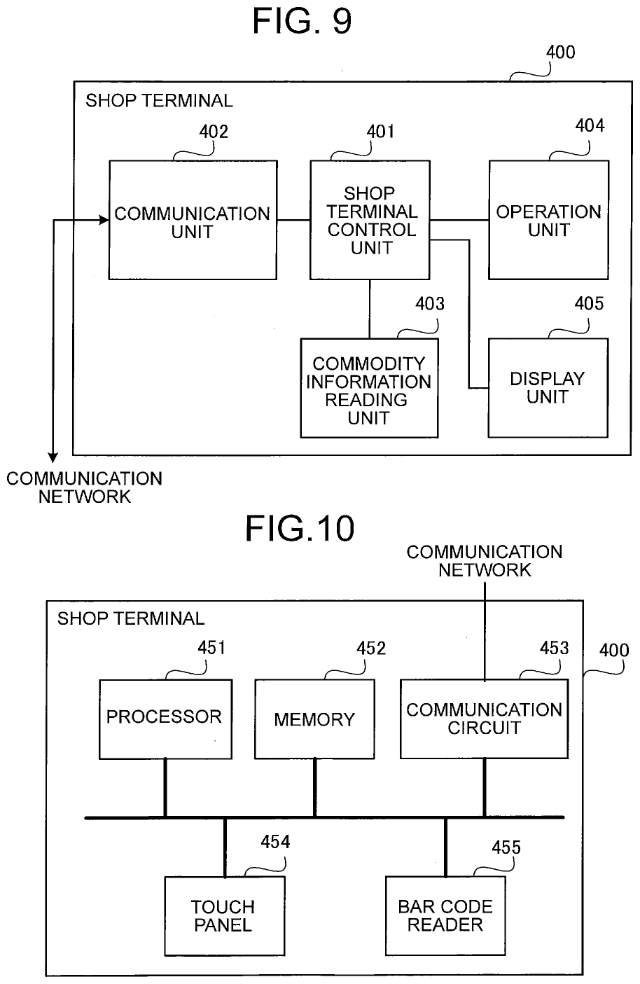

FIG. 9 is a functional block diagram schematically showing the configuration of the shop terminal 400 in FIG. 1. As shown in FIG. 9, the shop terminal 400 includes a communication unit 402 that executes communication with another device such as the management server 100 via the communication network 600, a shop terminal control unit 401, a commodity information reading unit 403 that reads a bar code as identification information on a commodity for sale, an operation unit 404 on which operations are performed, and a display unit 405 that displays information. The shop terminal 400 is a computer, for example. The shop terminal control unit 401 transmits a delivery request to the management server 100. Further, the shop terminal control unit 401 may transmit the parcel delivery request to the management server 100 in place of the user terminal 300. In this case, the shop terminal control unit 401 may transmit commodity information read by the commodity information reading unit 403 as information on the parcel to be delivered.

FIG. 10 is a diagram showing the hardware configuration of the shop terminal 400 in FIG. 9. As shown in FIG. 10, the shop terminal 400 includes a processor 451 such as a CPU, a memory 452 as a volatile storage device, a communication circuit 453 that executes the communication, a touch panel 454, and a bar code reader 455.

Functions of the shop terminal 400 are implemented by processing circuitry. The processing circuitry can be either dedicated hardware or the processor 451 executing a program stored in the memory 452 as a storage device. The storage device may be a non-transitory computer-readable storage medium storing the program. It is also possible to implement part of the configuration of the shop terminal 400 by dedicated hardware and part of the configuration of the shop terminal 400 by software or firmware. As above, the processing circuitry is capable of implementing the above-described functions by hardware, software, firmware or a combination of some of these means.

### (Hotel Terminal 500)

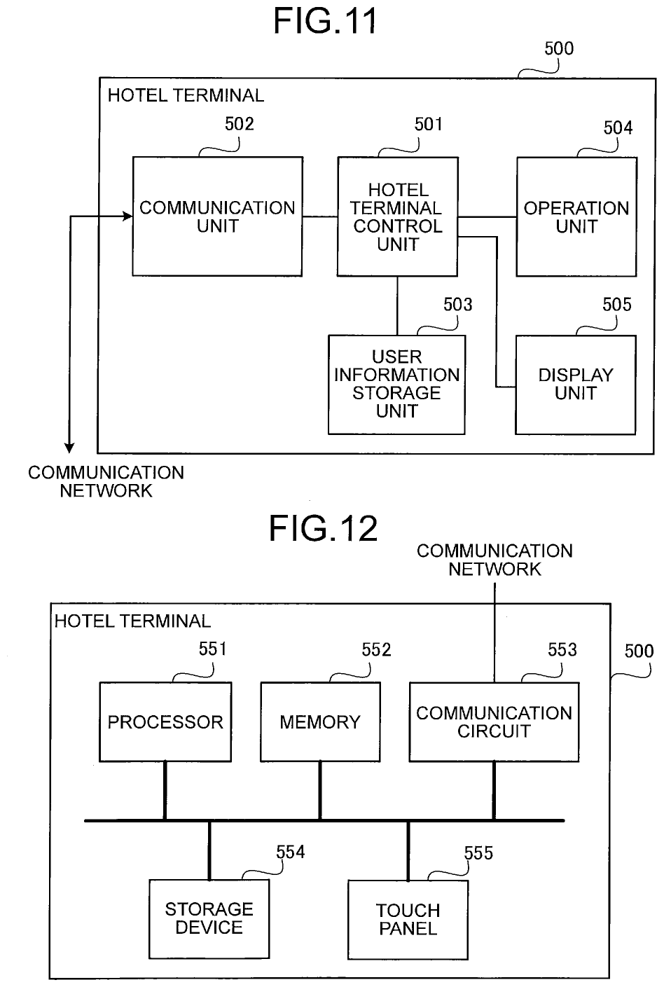

FIG. 11 is a functional block diagram schematically showing the configuration of the hotel terminal 500 in FIG. 1. As shown in FIG. 11, the hotel terminal 500 includes a communication unit 502 that executes communication with another device such as the management server 100 via the communication network 600, a hotel terminal control unit 501, a storage unit 503 that stores the user information, an operation unit 504 on which input operations are performed, and a display unit 505 that displays information. The hotel terminal 500 is a computer, for example. The hotel terminal control unit 501 is used for communication for storing the parcel to be delivered to the user in the storage compartment of the vehicle 200 arriving at the hotel 510 based on a request from the management server 100. Further, the hotel terminal control unit 501 may transmit the parcel delivery request to the management server 100 in place of the user terminal 300.

FIG. 12 is a diagram showing the hardware configuration of the hotel terminal 500 in FIG. 11. As shown in FIG. 12, the hotel terminal 500 includes a processor 551 such as a CPU, a memory 552 as a volatile storage device, a communication circuit 553 that executes the communication, a nonvolatile storage device 554, and a touch panel 555.

Functions of the hotel terminal 500 are implemented by processing circuitry. The processing circuitry can be either dedicated hardware or the processor 551 executing a program stored in the memory 552 as a storage device. The storage device may be a non-transitory computer-readable storage medium storing the program. It is also possible to implement part of the configuration of the hotel terminal 500 by dedicated hardware and part of the configuration of the hotel terminal 500 by software or firmware. As above, the processing circuitry is capable of implementing the above-described functions by hardware, software, firmware or a combination of some of these means.

### First Operation Example

FIGS. 13A to 13F are schematic diagrams for explaining a first operation example of the delivery system according to the embodiment. First, as shown in FIG. 13A, the user 310 requesting the delivery of a parcel 320 transmits a delivery request from the user terminal 300. The delivery request includes information indicating that the delivery destination is the hotel 510 as the accommodation. Further, the delivery request may include size information on the shipment parcel as the parcel 320 to be shipped. Furthermore, the delivery request may include designation of a pickup time such as “Please pick up about one hour from now.”, “Please pick up in over one hour from now.”, “Please pick up within one hour from now.”, or the like, for example. In other words, the request may include time information indicating that the responsible vehicle is desired to arrive in over a certain number of hours from a present time, and then the control unit selects the responsible vehicle according to the time information and issues a command regarding the traveling of the responsible vehicle.

As shown in FIGS. 13B and 13C, the user 310 after making the delivery request does not need to wait at a designated place at a set time, and thus can act and move freely in the area 700.

Thereafter, as shown in FIG. 13D, the responsible vehicle 210 arrives at the position of the user 310 freely acting and moving. At that time, the user 310 is notified that the responsible vehicle 210 has arrived to pick up the parcel by means of audio output, a display on a display unit of the responsible vehicle 210, a notification to the user terminal 300, or the like.

As shown in FIG. 13E, the responsible vehicle 210 performs authentication that the user 310 is the actual person who requested the delivery, and moves to the delivery destination (e.g., the hotel 510) after the parcel 320 is loaded onto the storage compartment of the responsible vehicle 210. Further, the responsible vehicle 210 notifies the management server 100 that the pickup is completed.

Thereafter, as shown in FIG. 13F, the user 310 can act freely (e.g., sight-seeing, shopping, dining, etc.) empty-handed.

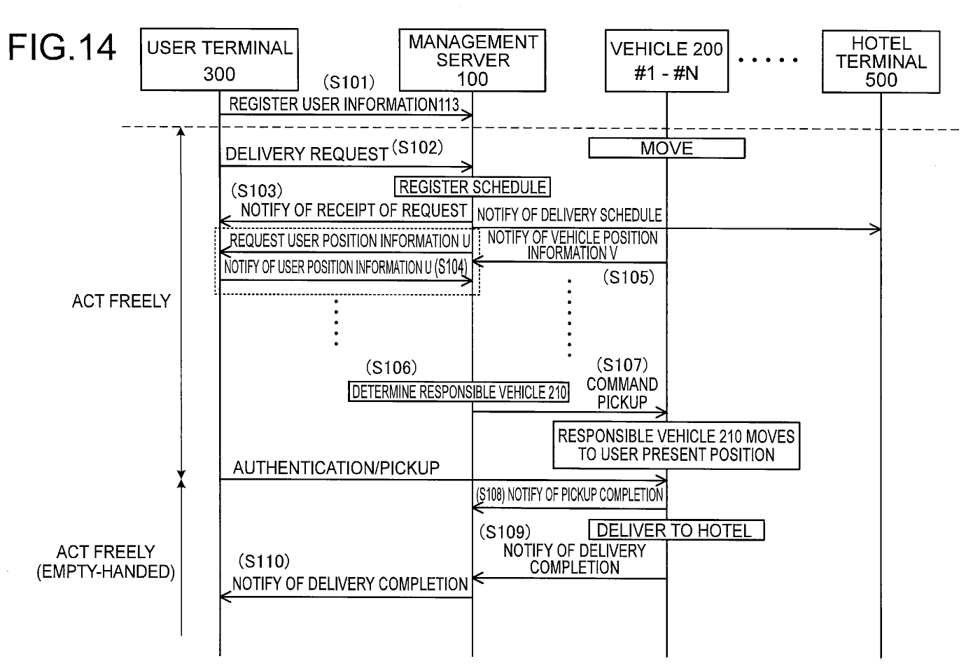

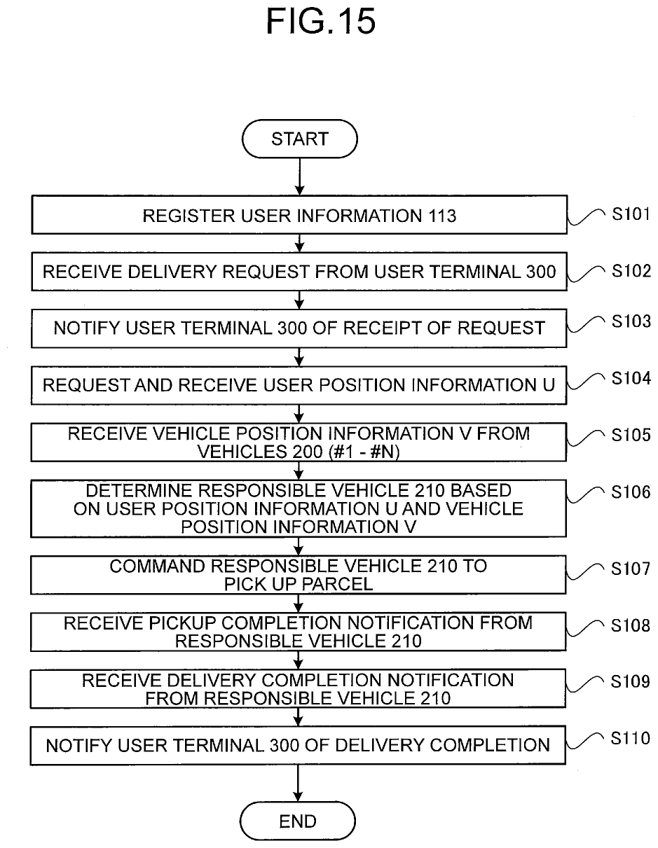

FIG. 14 is a sequence diagram showing the operation of the user terminal 300, the responsible vehicle 210 and the management server 100 in the first operation example. FIG. 15 is a flowchart showing the operation of the management server 100 in the first operation example.

First, in step S101, the user information is registered in the management server 100. The registration of the user information may be performed at the same time as an accommodation reservation for the hotel 510. Incidentally, the accommodation reservation for the hotel 510 may include a reservation for temporary use of a facility (e.g., taking a rest, using a restaurant, etc.) with no accommodation in the hotel 510.

Subsequently, in step S102, a delivery request is made to the management server 100. The management server 100 registers the delivery in a schedule list, and notifies the user terminal 300 of the receipt of the request in step S103. Further, the management server 100 may notify the hotel terminal 500 of the hotel 510 as the delivery destination about the delivery schedule.

Subsequently, in step S104, the management server 100 repeats a process of requesting the user position information U from the user terminal 300 and receiving the user position information U from the user terminal 300 until the pickup by the responsible vehicle 210 is completed. Further, the management server 100 in step S106 selects the responsible vehicle 210 to be dispatched for the pickup from among the vehicles 200 #1-#N moving in the area 700, and issues a command regarding the traveling for the pickup in step S107. The responsible vehicle 210 moves to the position of the user 310 freely acting and moving and notifies the user 310 that the responsible vehicle 210 has arrived to pick up the parcel.

Subsequently, the responsible vehicle 210 performs the authentication that the user 310 is the actual person who requested the delivery, and starts moving toward the hotel 510 as the delivery destination after the parcel 320 is loaded onto the storage compartment of the responsible vehicle 210. Further, in step S108, the responsible vehicle 210 notifies the management server 100 that the pickup is completed.

Subsequently, in step S109, the responsible vehicle 210 notifies the management server 100 that the delivery to the hotel 510 is completed. In step S110, the management server 100 notifies the user terminal 300 of the delivery completion.

In the case of the first operation example, the user 310 does not need to be at a designated place at a set time for the pickup, and can act and move freely in the area 700.

### Second Operation Example

In the above-described first operation example, the description is given of the operation of the delivery system when the user 310 does not want to carry the parcel 320. However, there are case where the user 310 wants to take a stroll in the area 700 together with a stuffed toy as a doll toy (e.g., while holding the stuffed toy in arms). Therefore, in a second operation example, a description will be given of a case where it is speculated that the user 310 wants to walk while carrying a commodity purchased in the area 700.

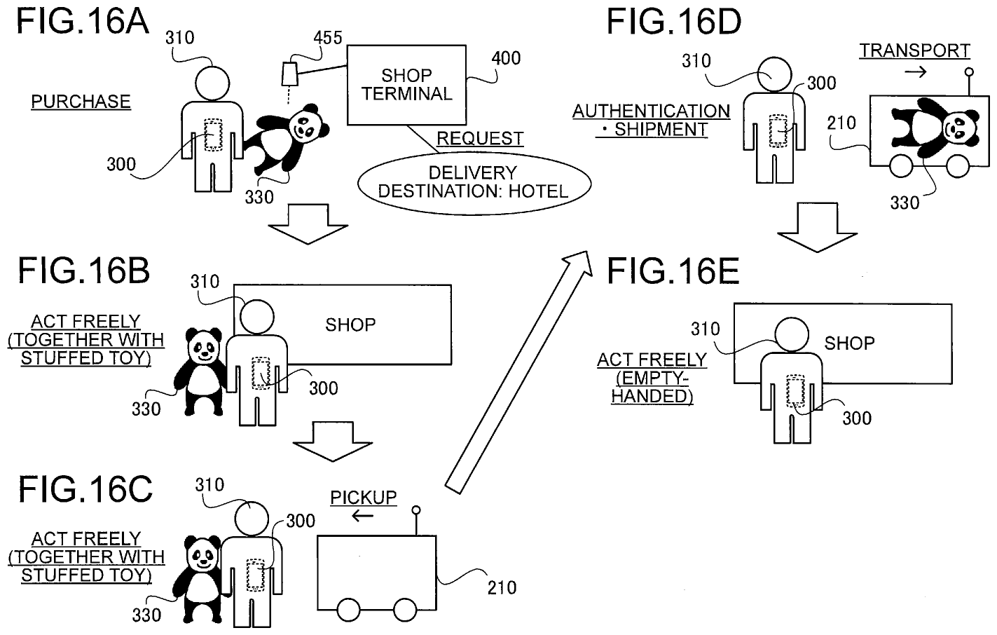

FIGS. 16A to 16E are schematic diagrams for explaining the second operation example of the delivery system according to the embodiment. First, as shown in FIG. 16A, the user 310 requesting the delivery of a parcel 330 as a purchased commodity transmits a delivery request from the shop terminal 400. The delivery request includes information indicating that the delivery destination is the hotel 510 as the accommodation. Further, the delivery request may include parcel information (e.g., size information) regarding the shipment parcel as the parcel 330 to be shipped. The parcel information can be information obtained by reading a bar code of the commodity with a bar code reader. Furthermore, the delivery request may include, for example, specific designation regarding the pickup time, or rough designation regarding the pickup time such as “Please pick up in a short while from now”. Further, the delivery request in FIG. 16A may also be made by use of the user terminal 300.

Subsequently, as shown in FIG. 16B, the user 310 after making the delivery request does not need to wait at a designated place at a set time, and thus can act and move freely in the area 700 together with the stuffed toy.

Thereafter, as shown in FIG. 16C, the responsible vehicle 210 arrives at the position of the user 310 freely acting and moving. The management server 100 estimates a desirable time until the responsible vehicle 210 arrives at the user position based on the user information on the user 310 (e.g., attributes of the user), commodity information on the purchased commodity (e.g., size and weight of the commodity), the type of the facility where the user is strolling, and the like. This estimation may be performed by using a learned model previously obtained by machine learning based on attributes of users, commodity information on purchased commodities, types of facilities for strolling, and the like. As the method of the machine learning, various methods are usable such as deep learning by using neural networks, decision tree, random forest, logistic regression, support vector machine or the like, for example. When the responsible vehicle 210 arrives at the user position, the responsible vehicle 210 is desired to notify the user 310 of the arrival by means of audio output, a display on the display unit of the responsible vehicle 210, a notification to the user terminal 300, or the like.

Subsequently, as shown in FIG. 16D, the responsible vehicle 210 performs the authentication that the user 310 is the actual person who requested the delivery, and moves to the delivery destination (e.g., the hotel 510) after the parcel 330 is loaded onto the storage compartment of the responsible vehicle 210. Further, the responsible vehicle 210 notifies the management server 100 that the pickup is completed.

Thereafter, as shown in FIG. 16F, the user 310 can act freely (e.g., sight-seeing, shopping, dining, etc.) empty-handed.

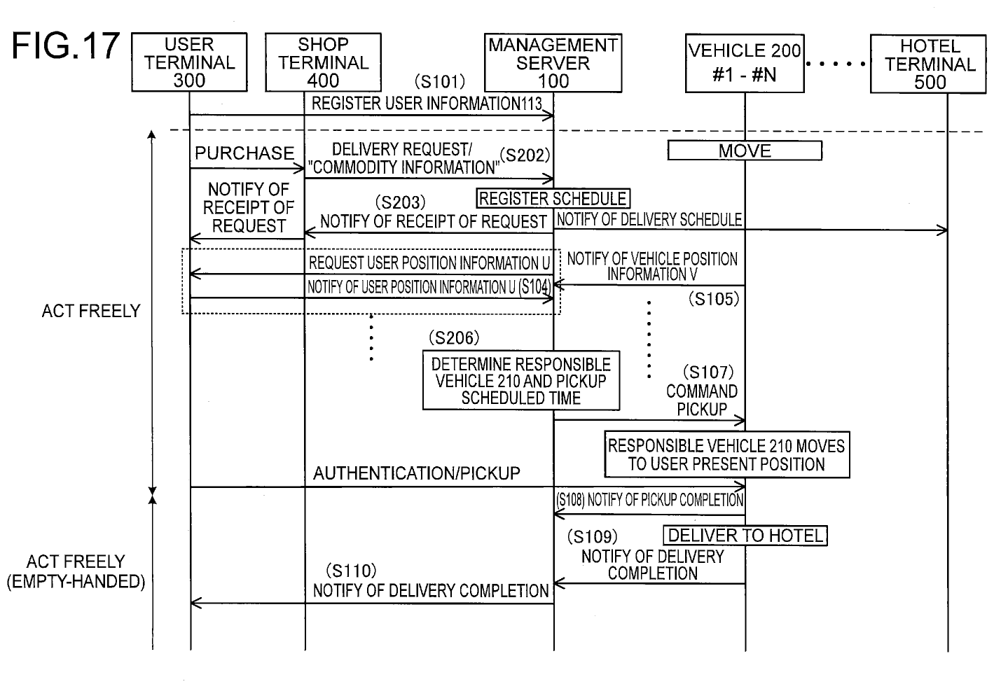

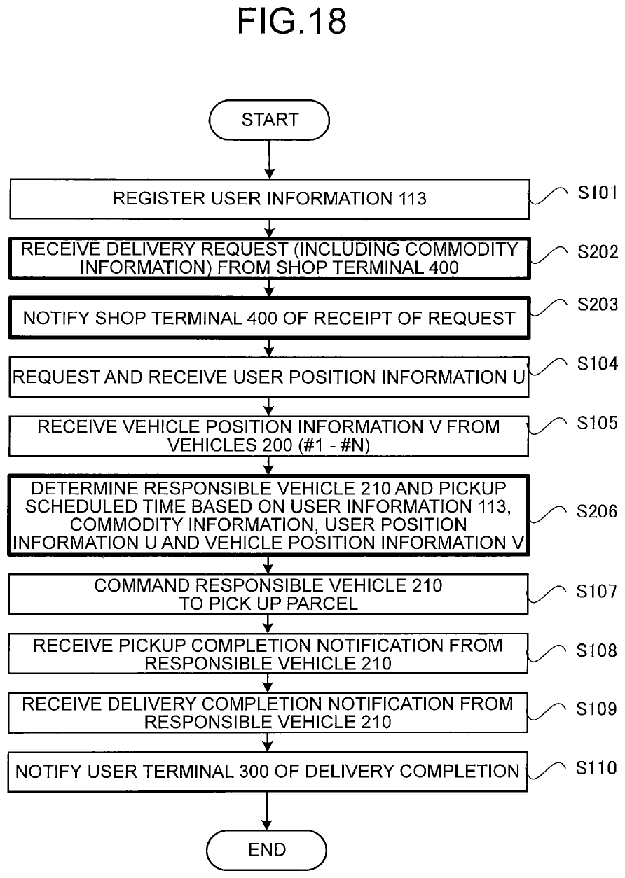

FIG. 17 is a sequence diagram showing the operation of the user terminal 300, the vehicles 200 and the management server 100 in the second operation example. FIG. 18 is a flowchart showing the operation of the management server 100 in the second operation example. The second operation example shown in FIGS. 17 and 18 differ from the first operation example shown in FIG. 14 and FIG. 15 in that the shop terminal 400 transmits the delivery request and a request receipt notification is transmitted to the shop terminal 400 (or both of the shop terminal 400 and the user terminal 300) (steps S202 and S203) and the management server 100 determines the responsible vehicle 210 and the pickup time based on the user information 113, the commodity information, the user position information U and the vehicle position information V (step S206). Except for the above-described features, the second operation example is the same as the first operation example.

In the case of the second operation example, the user 310 does not need to be at a designated place at a set time for the pickup, and can act and move freely in the area 700.

Further, the user 310 can take a stroll in the facility together with the purchased stuffed toy for an appropriate time not making the user 310 too tired, and thus the level of enjoyment felt by the user 310 can be increased and the user 310's level of satisfaction with the use of the facility can be increased.

### Third Operation Example

In the above-described first and second operation examples, the description is given of the operation of the delivery system for delivering the parcel 320 to the hotel 510 as a facility other than the commercial facility 710. However, there are cases where the user 310 exiting from the commercial facility 710 goes to a different facility (e.g., the entertainment facility 720). Therefore, in a third operation example, a description will be given of a case where the user 310 receives a parcel 340 as the user 310's own bag at an exit of the commercial facility 710.

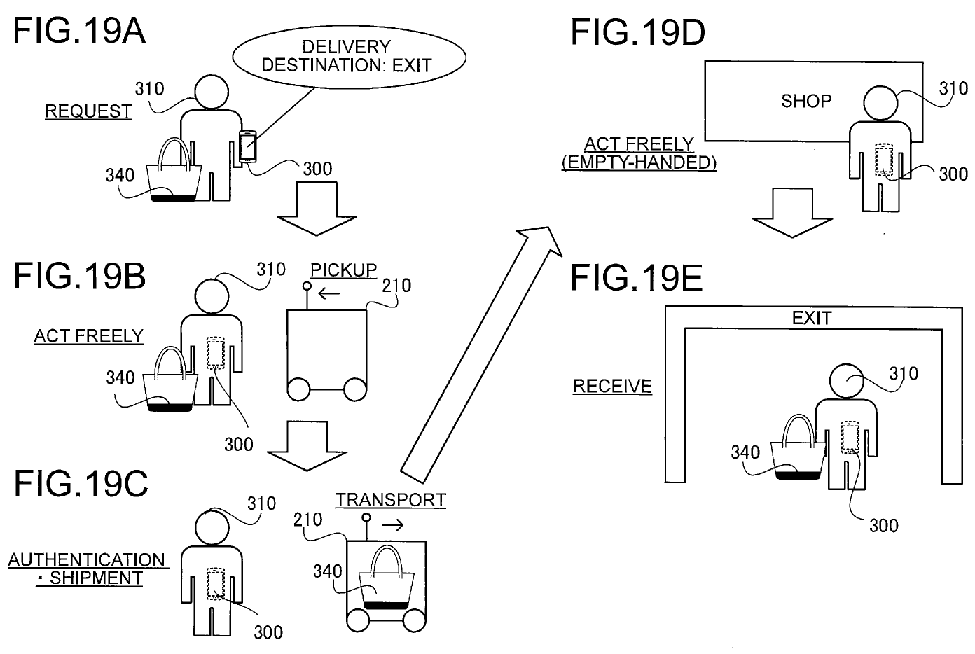

FIGS. 19A to 19E are schematic diagrams for explaining the third operation example of the delivery system according to the embodiment. First, as shown in FIG. 19A, the user 310 requesting the delivery of the parcel 340 transmits a delivery request from the user terminal 300. The delivery request includes information indicating that the delivery destination is an exit of the commercial facility 710 in which the user 310 is currently situated (e.g., parcel receiving place in the vicinity of the exit). A facility terminal as a computer is provided in the parcel receiving place in the vicinity of the exit and executes processes such as authentication for the reception of the parcel 340 by the user 310. The configuration of the facility terminal is the same as that of the hotel terminal.

Subsequently, as shown in FIG. 19B, the user 310 after making the delivery request does not need to wait at a designated place at a set time, and thus can act and move freely in the commercial facility 710.

Thereafter, as shown in FIG. 19C, the responsible vehicle 210 arrives at the position of the user 310 freely acting and moving. The responsible vehicle 210 performs the authentication that the user 310 is the actual person who requested the delivery, and moves to the exit as the delivery destination after the parcel 340 is loaded onto the storage compartment of the responsible vehicle 210. Further, the responsible vehicle 210 notifies the management server 100 that the pickup is completed.

Thereafter, as shown in FIG. 19D, the user 310 can act freely (e.g., sight-seeing, shopping, dining, etc.) empty-handed. As shown in FIG. 19E, the user 310 can receive the parcel 340 at the exit of the commercial facility 710 and move from the commercial facility 710 to another place.

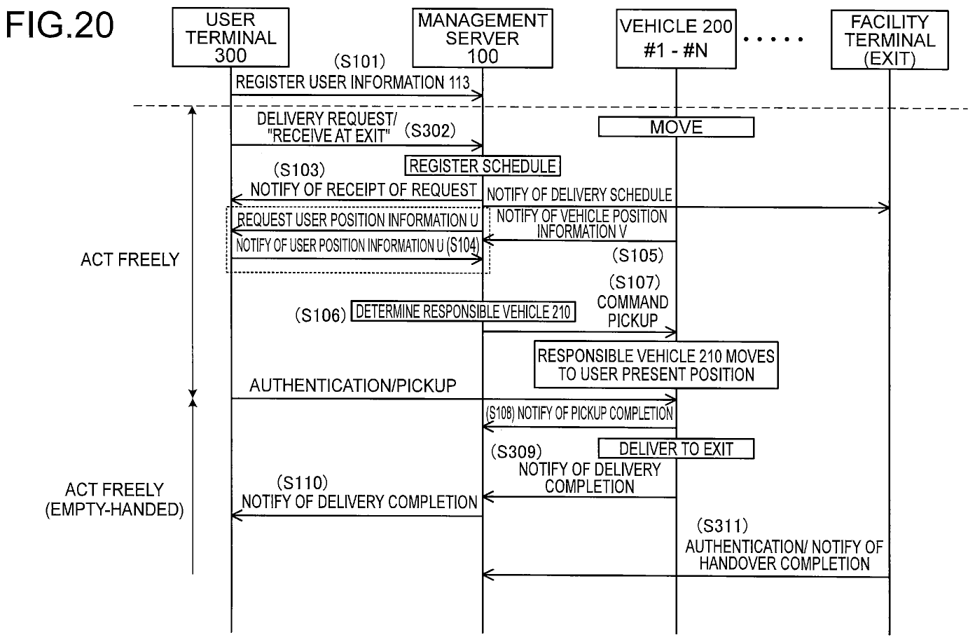

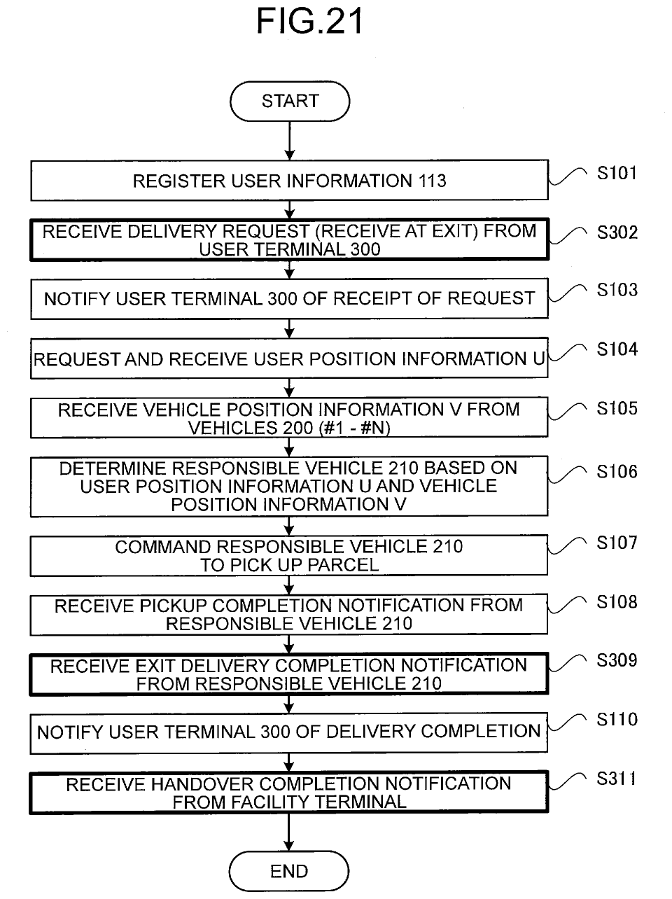

FIG. 20 is a sequence diagram showing the operation of the user terminal 300, the vehicles 200 and the management server 100 in the third operation example. FIG. 21 is a flowchart showing the operation of the management server 100 in the third operation example. The third operation example shown in FIG. 20 and FIG. 21 differ from the first operation example shown in FIG. 14 and FIG. 15 in that the delivery destination of the parcel 340 is the exit of the facility (step S302) and the management server 100 is notified that the parcel 340 has been delivered to the exit of the facility (step S309). Except for the above-described features, the third operation example is the same as the first operation example.

In the case of the third operation example, the user 310 does not need to be at a designated place at a set time for the pickup, and can act and move freely in the area 700.

### Fourth Operation Example

In the above-described first to third operation examples, the description is given of the operations in which the responsible vehicle 210 picks up a parcel of one user 310. However, there are cases where the user 310 does not need the pickup in a rush. In such cases, efficiency of the pickup increases if a responsible vehicle 210 having a plurality of storage compartments executes the pickup for a plurality of users successively. Therefore, in a fourth operation example, a description will be given of a case of using a responsible vehicle 210 having a plurality of storage compartments.

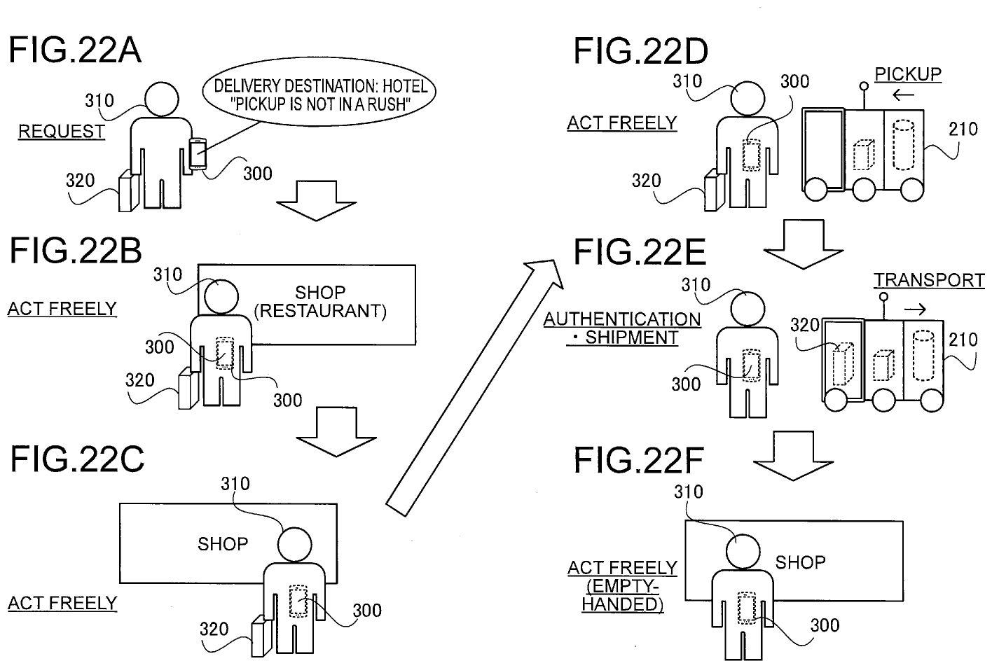

FIGS. 22A to 22F are schematic diagrams for explaining the fourth operation example of the delivery system according to the embodiment. First, as shown in FIG. 22A, the user 310 requesting the delivery of a parcel 320 transmits a delivery request from the user terminal 300. The delivery request includes information indicating that the delivery destination is the hotel 510 and “the pickup is not in a rush”.

Subsequently, as shown in FIGS. 22B and 22C, the user 310 after making the delivery request does not need to wait at a designated place at a set time, and thus can act and move freely in the commercial facility 710.

Thereafter, as shown in FIG. 22D, the responsible vehicle 210 having a plurality of storage compartments arrives at the position of the user 310 freely acting and moving. Subsequently, as shown in FIG. 22E, the responsible vehicle 210 performs the authentication that the user 310 is the actual person who requested the delivery, and moves to the hotel 510 as the delivery destination after the parcel 340 is loaded onto one of the storage compartments of the responsible vehicle 210. Further, the responsible vehicle 210 notifies the management server 100 that the pickup is completed.

Thereafter, as shown in FIG. 22F, the user 310 can act freely (e.g., sight-seeing, shopping, dining, etc.) empty-handed.

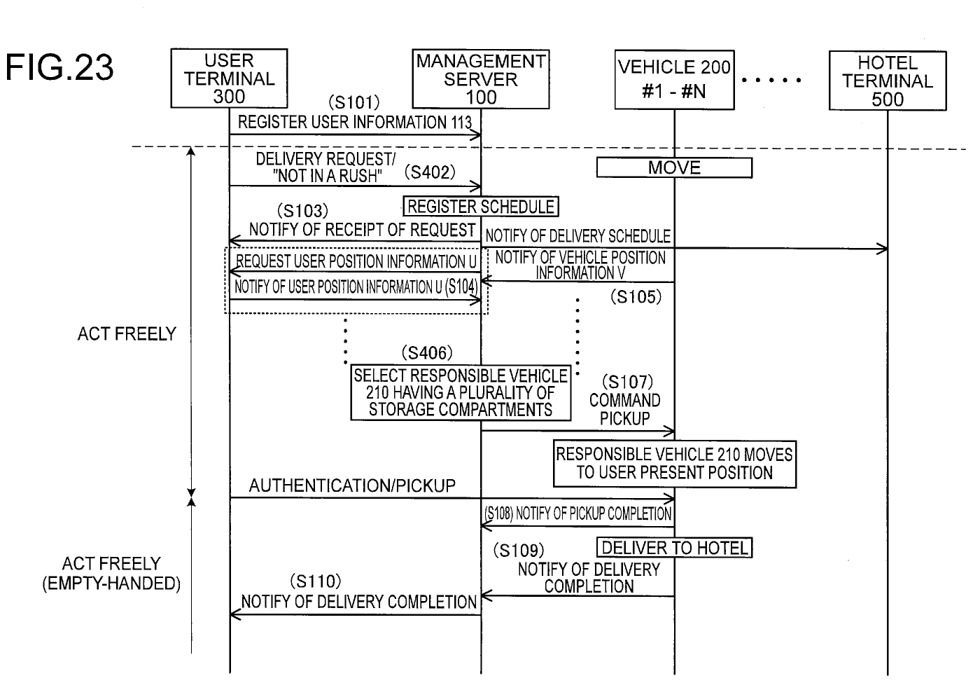

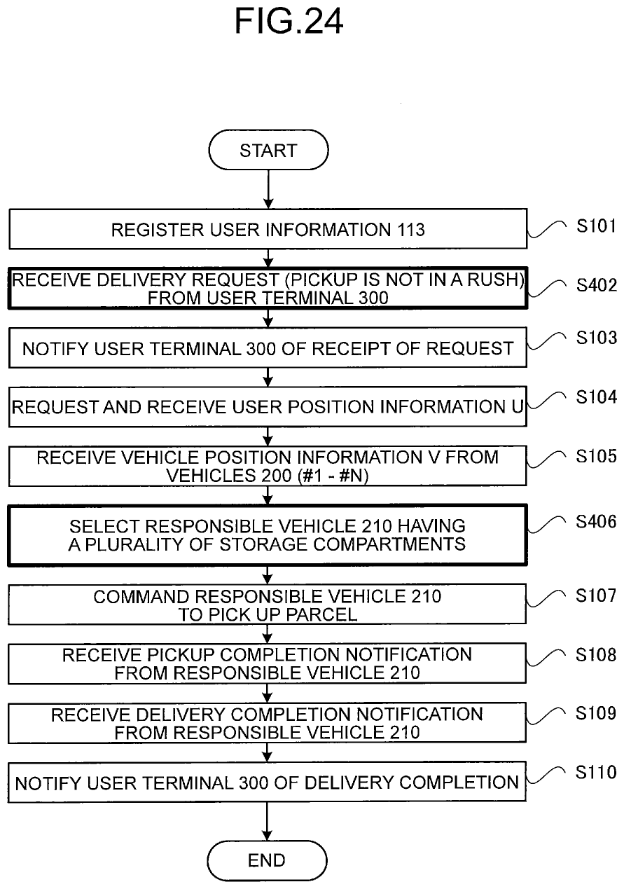

FIG. 23 is a sequence diagram showing the operation of the user terminal 300, the vehicles 200 and the management server 100 in the fourth operation example. FIG. 24 is a flowchart showing the operation of the management server 100 in the fourth operation example. The fourth operation example shown in FIG. 23 and FIG. 24 differ from the first operation example shown in FIG. 14 and FIG. 15 in that the notification that the pickup of the parcel 320 is not in a rush is made (step S402) and the responsible vehicle 210 having a plurality of storage compartments is selected in this case (step S406). Except for the above-described features, the fourth operation example is the same as the first operation example.

In the case of the fourth operation example, the user 310 does not need to be at a designated place at a set time for the pickup, and can act and move freely in the area 700. Further, the efficiency of the pickup increases since a responsible vehicle 210 having a plurality of storage compartments is used.

### Fifth Operation Example

In the above-described first to fourth operation examples, the description is given of the operations in which information on the user 310 is used as the user information 113 or no user information 113 is used. However, there are cases where the convenience for the user 310 as a user of a facility is increased by using information on the user 310 and the family of the user 310. Therefore, in a fifth operation example, a description will be given of a case where the responsible vehicle 210 is determined in consideration of information on the user 310 as the delivery requester and the family of the user 310 (a group acting together with the user 310).

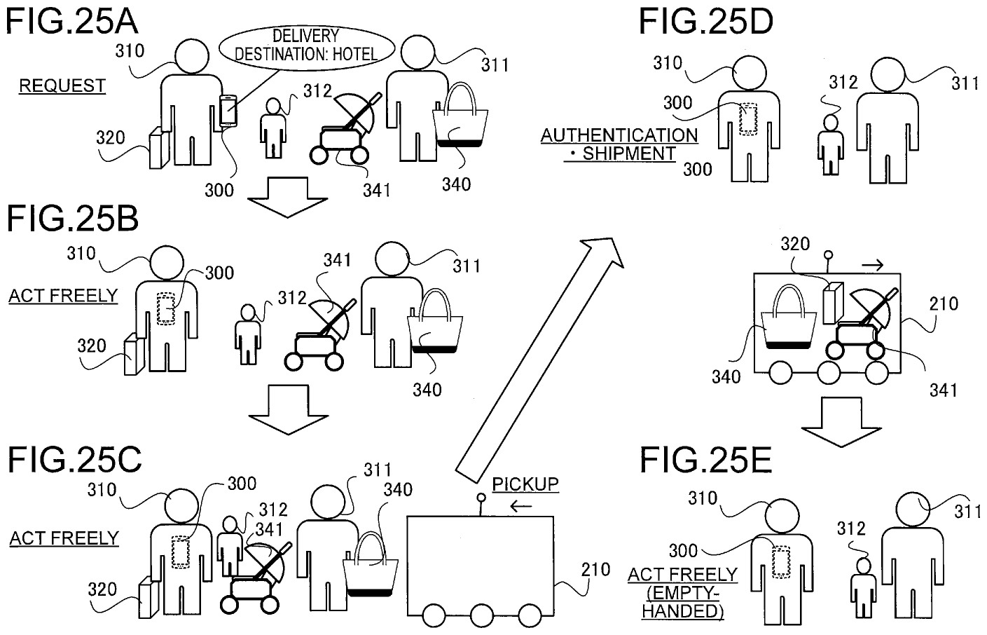

FIGS. 25A to 25E are schematic diagrams for explaining the fifth operation example of the delivery system according to the embodiment. First, as shown in FIG. 25A, the user 310 requesting the delivery of a parcel 320 transmits a delivery request from the user terminal 300. The delivery request includes information indicating that the delivery destination is the hotel 510, the user 310 is acting in a group of a total of three people including the user's wife and child, and the number of parcels is three.

Subsequently, as shown in FIG. 25B, the group of the user 310 after making the delivery request does not need to wait at a designated place at a set time, and thus can act and move freely in the commercial facility 710.

Thereafter, as shown in FIG. 25C, the responsible vehicle 210 having a storage compartment with a capacity greater than a predetermined normal (standard) capacity arrives at the position of the group of the user 310 freely acting and moving. The management server 100 estimates a desirable size of the storage compartment of the responsible vehicle 210 based on the user information 113 on the user 310 (e.g., family composition of the user). This estimation may be performed by using a learned model previously generated by machine learning based on attributes of users 310, compositions of families, commodity information on purchased commodities, types of facilities for strolling, and the like. For example, in cases where a child is at an age for riding in a stroller which is a relatively large parcel, the number of children is large, or the like, a storage compartment with a large capacity becomes necessary as the storage compartment of the responsible vehicle 210. Incidentally, as the method of the machine learning, various methods are usable such as deep learning by using neural networks, decision tree, random forest, logistic regression, support vector machine or the like, for example.

Subsequently, as shown in FIG. 25D, the responsible vehicle 210 performs the authentication that the user 310 is the actual person who requested the delivery, and moves to the hotel 510 as the delivery destination after parcels 340, 341 and 320 are loaded onto the storage compartment of the responsible vehicle 210. Further, the responsible vehicle 210 notifies the management server 100 that the pickup is completed.

Thereafter, as shown in FIG. 25E, the user 310 can act freely (e.g., sight-seeing, shopping, dining, etc.) empty-handed.

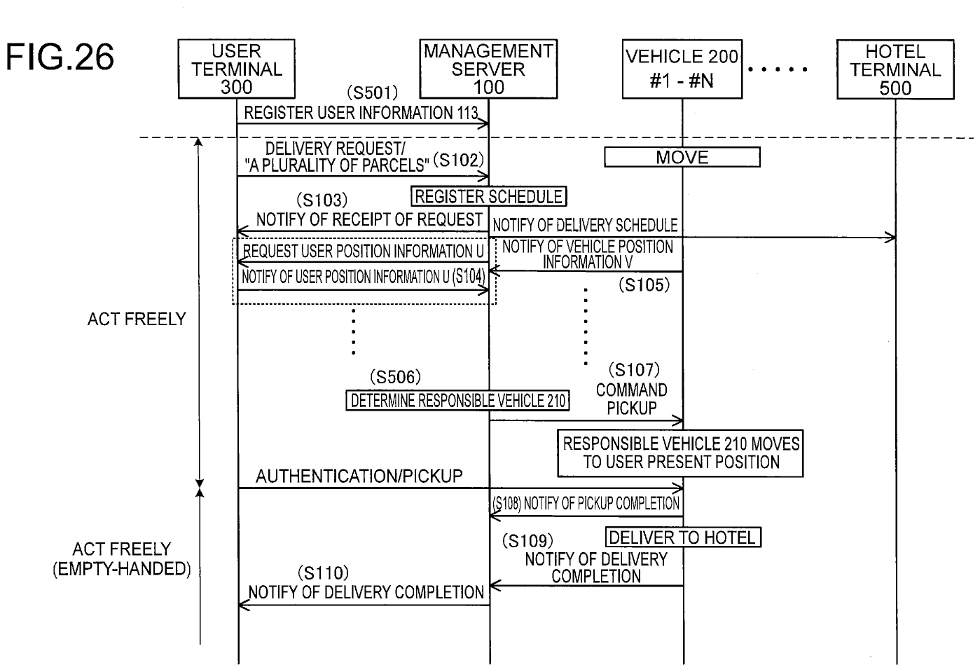

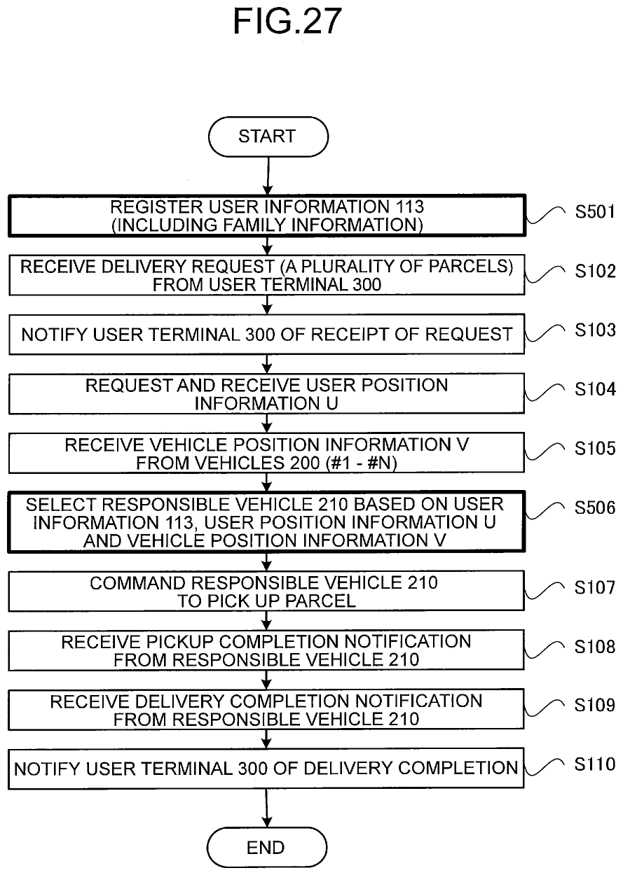

FIG. 26 is a sequence diagram showing the operation of the user terminal 300, the vehicles 200 and the management server 100 in the fifth operation example. FIG. 27 is a flowchart showing the operation of the management server 100 in the fifth operation example. The fifth operation example shown in FIG. 26 and FIG. 27 differ from the first operation example shown in FIG. 14 and FIG. 15 in that the user information 113 includes family information on the user (step S501) and the responsible vehicle 210 is selected (i.e., determined) based on the user information 113, the user position information U and the vehicle position information V (step S506). Except for the above-described features, the fifth operation example is the same as the first operation example.

In the case of the fifth operation example, the user 310 and the user's wife and child do not need to be at a designated place at a set time for the pickup, and can act and move freely in the area 700. Further, since it becomes possible to use a responsible vehicle 210 having a storage compartment with a large capacity, the parcels can be stored without fail.

### Sixth Operation Example

In the above-described first to fifth operation examples, the description is given of the operations of the delivery system in cases where the user 310 loads the shipment parcel onto the storage compartment of the responsible vehicle 210. In a sixth operation example, a description will be given of the operation of the delivery system in a case where the user 310 receives the reception parcel from the storage compartment of the responsible vehicle 210. Specifically, the description will be given of an operation example of the delivery system in a case where a coat left in the user 310's room in the hotel 510 is delivered to the user 310 walking in the commercial facility 710.

FIGS. 28A to 28F are schematic diagrams for explaining the sixth operation example of the delivery system according to the embodiment. First, as shown in FIG. 28A, a request for delivering a coat 350 as a parcel from the user 310's room in the hotel 510 to the user 310 in the commercial facility 710 is transmitted from the user terminal 300. The delivery request includes information indicating that the delivery destination is the user 310 moving in the area 700 and the parcel is the coat 350 left in the user's room in the hotel 510.

Subsequently, as shown in FIG. 28B, the responsible vehicle 210 is determined by the management server 100 and arrives at the hotel 510 (e.g., front desk) in the area 700. After the coat 350 is stored in the storage compartment of the responsible vehicle 210 by a clerk of the hotel 510 as shown in FIG. 28C, the responsible vehicle 210 arrives at the position of the user 310 freely acting and moving in the commercial facility 710 as shown in FIG. 28D. Incidentally, the storing of the coat 350 may also be done when the responsible vehicle 210 itself has moved to the room, in which case the coat 350 is stored in the storage compartment by a person in the room (e.g., a clerk of the hotel 510, a guest in the room, or the like).

Subsequently, as shown in FIG. 28E, the responsible vehicle 210 performs the authentication that the user 310 is the actual person who requested the delivery, and permits the taking out of the coat 350 stored in the storage compartment of the responsible vehicle 210. After the coat 350 is taken out of the responsible vehicle 210 as shown in FIG. 28F, the responsible vehicle 210 notifies the management server 100 that the delivery of the parcel picked up is completed.

Thereafter, the user 310 can wear the coat and act freely.

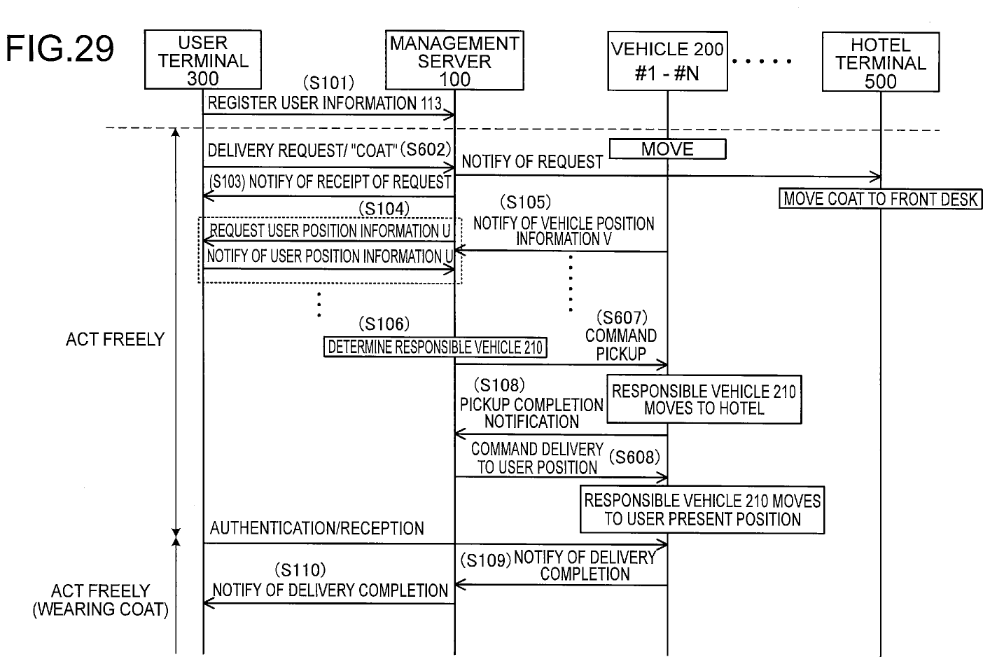

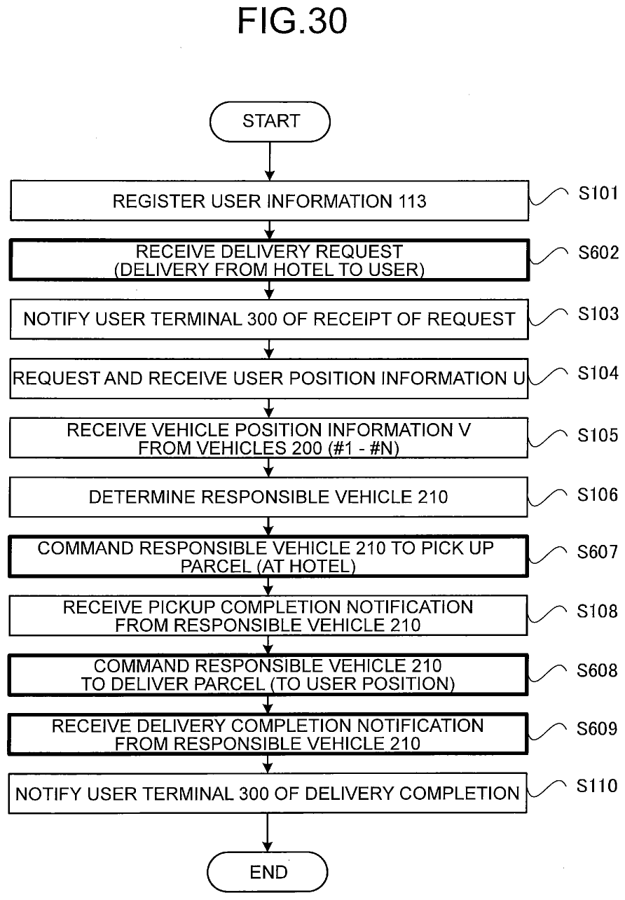

FIG. 29 is a sequence diagram showing the operation of the user terminal 300, the vehicles 200 and the management server 100 in the sixth operation example. FIG. 30 is a flowchart showing the operation of the management server 100 in the sixth operation example. The sixth operation example shown in FIG. 29 and FIG. 30 differ from the first operation example shown in FIG. 14 and FIG. 15 in that the pickup-delivery of picking up a parcel at the hotel 510 and delivering the parcel to the user 310 is requested (step S602) and the responsible vehicle 210 goes to the hotel 510, picks up the coat 350 as the parcel to be delivered to the user, and thereafter moves to the user position and delivers the parcel (steps S607, S608 and S609). Except for the above-described features, the sixth operation example is the same as the first operation example.

In the case of the sixth operation example, the user 310 does not need to be at a designated place at a set time for the pickup, and can act and move freely in the area 700.

### DESCRIPTION OF REFERENCE CHARACTERS

100: management server (delivery management device), 101: control unit, 102: communication unit, 111: map information, 112: vehicle information, 113: user information, 200: vehicle, 210: responsible vehicle, 300: user terminal, 310: user, 320, 330, 340: parcel (shipment parcel), 350: parcel (reception parcel), 400: shop terminal, 500: hotel terminal (shipper terminal), 510: hotel (accommodation facility), 600: communication network, 700: area, 710: commercial facility, 720: entertainment facility.

What is claimed is:

1. A delivery management device comprising:
processing circuitry
to execute communication with a plurality of vehicles each of which autonomously travels in a predetermined area and to output vehicle position information indicating a vehicle present position; and
to acquire information from a storage device storing map information indicating a map of the predetermined area, vehicle information indicating types of the plurality of vehicles, and user information including information regarding a user terminal outputting user position information indicating a user present position and information regarding a user, and to issue commands regarding the traveling of the plurality of vehicles based on the information,
wherein the processing circuitry
acquires the vehicle position information and the user position information when a request for delivery of a parcel is received, the request including no designated pickup position of a shipment parcel in the predetermined area or no designated reception position of a reception parcel in the predetermined area,
selects one vehicle among the plurality of vehicles based on contents of the request, the information acquired from the storage device, the vehicle position information and the user position information and makes the selected vehicle as a responsible vehicle move to the user present position, and
receives a pickup completion notification indicating that the responsible vehicle moved to the user present position and the shipment parcel has been loaded onto the responsible vehicle or a delivery completion notification indicating that the responsible vehicle arrived at the user present position and the reception parcel has been taken out of the responsible vehicle.

2. The delivery management device according to claim 1, wherein when the request is a request for delivery of the shipment parcel, the request is transmitted from the user terminal or a shop terminal of a shop where the shipment parcel is purchased.

3. The delivery management device according to claim 2, wherein when the request is transmitted from the user terminal, the request includes size information on the shipment parcel.

4. The delivery management device according to claim 2, wherein when the request is transmitted from the shop terminal, the request includes identification information on the purchased shipment parcel.

5. The delivery management device according to claim 2, wherein the request includes information designating a delivery destination of the shipment parcel in the predetermined area.

6. The delivery management device according to claim 2, wherein when the user information indicates that the user is accompanied by the user's family, the processing circuitry selects a vehicle in which a capacity of a storage compartment for storing parcels is larger than a normal capacity, as the responsible vehicle.

7. The delivery management device according to claim 2, wherein when the request does not designate a time of pickup of the shipment parcel or the pickup of the shipment parcel is designated to be done in a time period longer than or equal to a predetermined time span, the processing circuitry selects a vehicle having a plurality of storage compartments for storing parcels, as the responsible vehicle.

8. The delivery management device according to claim 2, wherein when the request includes time information indicating that the responsible vehicle is desired to arrive in over a certain number of hours from a present time, the processing circuitry selects the responsible vehicle according to the time information and issues a command regarding the traveling of the responsible vehicle.

9. The delivery management device according to claim 1, wherein when the request is a request for delivery of the reception parcel, the request is transmitted from the user terminal to the processing circuitry and a shipper terminal as a terminal of a shipper shipping out the reception parcel.

10. The delivery management device according to claim 9, wherein the processing circuitry
makes the responsible vehicle move to a position of the shipper terminal, and
makes the responsible vehicle move to the user present position after confirming completion of loading of the reception parcel onto the responsible vehicle.

11. The delivery management device according to claim 9, wherein
the shipper is a hotel, and
the shipper terminal is a hotel terminal provided in the hotel.

12. A delivery system comprising:
the delivery management device according to claim 1; and
the plurality of vehicles.

13. A delivery management method executed by a delivery management device that executes communication with a plurality of vehicles each of which autonomously travels in a predetermined area and outputs vehicle position information indicating a vehicle present position, acquires information from a storage device storing map information indicating a map of the predetermined area, vehicle information indicating types of the plurality of vehicles, and user information including information regarding a user terminal outputting user position information indicating a user present position and information regarding a user, and issues commands regarding the traveling of the plurality of vehicles based on the information, the method comprising:
acquiring the vehicle position information and the user position information when a request for delivery of a parcel is received, the request including no designated pickup position of a shipment parcel in the predetermined area or no designated reception position of a reception parcel in the predetermined area;
selecting one vehicle among the plurality of vehicles based on contents of the request, the information acquired from the storage device, the vehicle position information and the user position information and making the selected vehicle as a responsible vehicle move to the user present position; and
receiving a pickup completion notification indicating that the responsible vehicle moved to the user present position and the shipment parcel has been loaded onto the responsible vehicle or a delivery completion notification indicating that the responsible vehicle arrived at the user present position and the reception parcel has been taken out of the responsible vehicle.

14. A non-transitory computer-readable storage medium storing a delivery management program executed by a computer that executes communication with a plurality of vehicles each of which autonomously travels in a predetermined area and outputs vehicle position information indicating a vehicle present position, acquires information from a storage device storing map information indicating a map of the predetermined area, vehicle information indicating types of the plurality of vehicles, and user information including information regarding a user terminal outputting user position information indicating a user present position and information regarding a user, and issues commands regarding the traveling of the plurality of vehicles based on the information,
wherein the delivery management program causes the computer to execute:
acquiring the vehicle position information and the user position information when a request for delivery of a parcel is received, the request including no designated pickup position of a shipment parcel in the predetermined area or no designated reception position of a reception parcel in the predetermined area;
selecting one vehicle among the plurality of vehicles based on contents of the request, the information acquired from the storage device, the vehicle position information and the user position information and making the selected vehicle as a responsible vehicle move to the user present position; and
receiving a pickup completion notification indicating that the responsible vehicle moved to the user present position and the shipment parcel has been loaded onto the responsible vehicle or the delivery completion notification indicating that the responsible vehicle arrived at the user present position and a reception parcel has been taken out of the responsible vehicle.
